(19) United States
(12) Patent Application Publication
(10) Pub. No.: US 2024/0312679 A1
(43) Pub. Date: Sep. 19, 2024

(54) CHIP RESISTOR AND METHOD OF MANUFACTURING THE SAME

(71) Applicant: ROHM CO., LTD., Kyoto-shi (JP)

(72) Inventor: Kosaku TANAKA, Kyoto-shi (JP)

(21) Appl. No.: 18/672,850

(22) Filed: May 23, 2024

Related U.S. Application Data
(63) Continuation of application No. PCT/JP2022/043951, filed on Nov. 29, 2022.

(30) Foreign Application Priority Data
Dec. 1, 2021 (JP) 2021-195305

(51) Int. Cl. H01C 17/00; H01C 1/144

(52) U.S. Cl. CPC H01C 17/006; H01C 1/144

(57) ABSTRACT

The chip resistor includes a first electrode layer, a second electrode layer, and a resistor body. The resistor body includes a first main surface, a second main surface, a first side surface, and a second side surface. The first electrode layer is connected to the first end of the second main surface on the side of the first side surface. The second electrode layer is connected to the second end of the second main surface on the side of the second side surface. The second electrode layer is spaced apart from the first electrode layer by a first interval. In a plan view viewed from a direction perpendicular to the first main surface, the protruding length of the first electrode layer from the first side surface is 0 mm or more and equal to or less than 0.5 times the first interval.

### TECHNICAL FIELD

The present disclosure relates to a chip resistor and a method of manufacturing the same.

### BACKGROUND ART

Conventionally, chip resistors are known. For example, WO 2012/157435 discloses a chip resistor in which a plate-like first electrode and a plate-like second electrode are connected to both end surfaces of a resistor body. Each of the first electrode and the second electrode includes a plate portion and an inclined portion. The inclined portion connects the plate portion and an end of the resistor body. Since the inclined portion is formed in this manner, when the plate portion of the first electrode and the plate portion of the second electrode are bonded to the mounting substrate, a gap is formed between the mounting substrate and the resistor body. The gap is configured to insulate the resistor body from the mounting substrate.

### CITATION LIST

### Patent Literature

PTL 1: WO 2012/157435

### BRIEF DESCRIPTION OF DRAWINGS

FIG. 1 is a schematic plan view illustrating a chip resistor according to a first embodiment;

FIG. 2 is a schematic cross-sectional view taken along a line II-II of FIG. 1;

FIG. 3 is an enlarged schematic cross-sectional view of a region III in FIG. 2;

FIG. 4 is a partial cross-sectional schematic view illustrating an electronic device including the chip resistor illustrated in FIG. 1;

FIG. 5 is a flowchart illustrating a method of manufacturing the chip resistor illustrated in FIG. 1;

FIG. 6 is a schematic view illustrating a method of manufacturing the chip resistor illustrated in FIG. 5;

FIG. 7 is a schematic cross-sectional view taken along a line VII-VII of FIG. 6;

FIG. 8 is a schematic cross-sectional view illustrating the method of manufacturing the chip resistor illustrated in FIG. 5;

FIG. 9 is a schematic view illustrating the method of manufacturing the chip resistor illustrated in FIG. 5;

FIG. 10 is a schematic cross-sectional view illustrating the method of manufacturing the chip resistor illustrated in FIG. 5;

FIG. 11 is a schematic cross-sectional view illustrating a belt-like workpiece obtained by the step illustrated in FIG. 10;

FIG. 12 is a schematic cross-sectional view illustrating a first modification of the chip resistor illustrated in FIG. 1;

FIG. 13 is a schematic cross-sectional view illustrating a method of manufacturing the chip resistor illustrated in FIG. 12;

FIG. 14 is a schematic plan view illustrating a second modification of the chip resistor illustrated in FIG. 1;

FIG. 15 is a schematic view illustrating a method of manufacturing the chip resistor illustrated in FIG. 14;

FIG. 16 is a schematic cross-sectional view illustrating a chip resistor according to a second embodiment;

FIG. 17 is a partial cross-sectional schematic view illustrating a substrate on which the chip resistor illustrated in FIG. 16 is mounted;

FIG. 18 is a schematic view illustrating a method of manufacturing the chip resistor illustrated in FIG. 16;

FIG. 19 is a schematic plan view illustrating a chip resistor according to a third embodiment;

FIG. 20 is a schematic plan view illustrating a chip resistor according to a fourth embodiment; and

FIG. 21 is a schematic view illustrating a method of manufacturing the chip resistor illustrated in FIG. 20.

### DESCRIPTION OF EMBODIMENTS

Hereinafter, embodiments of the present disclosure will be described. The same components are denoted by the same reference numerals, and the description thereof will not be repeated.

### First Embodiment

### <Configuration of Chip Resistor>

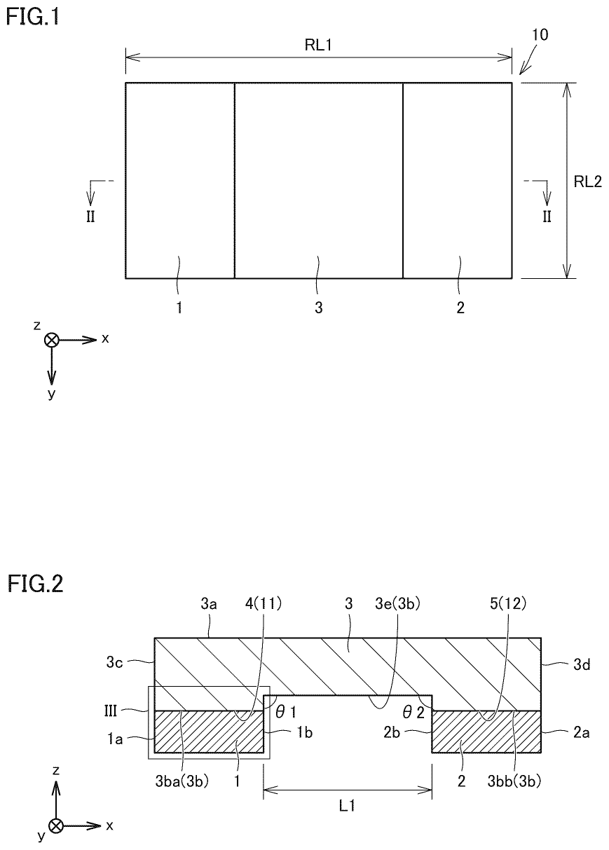

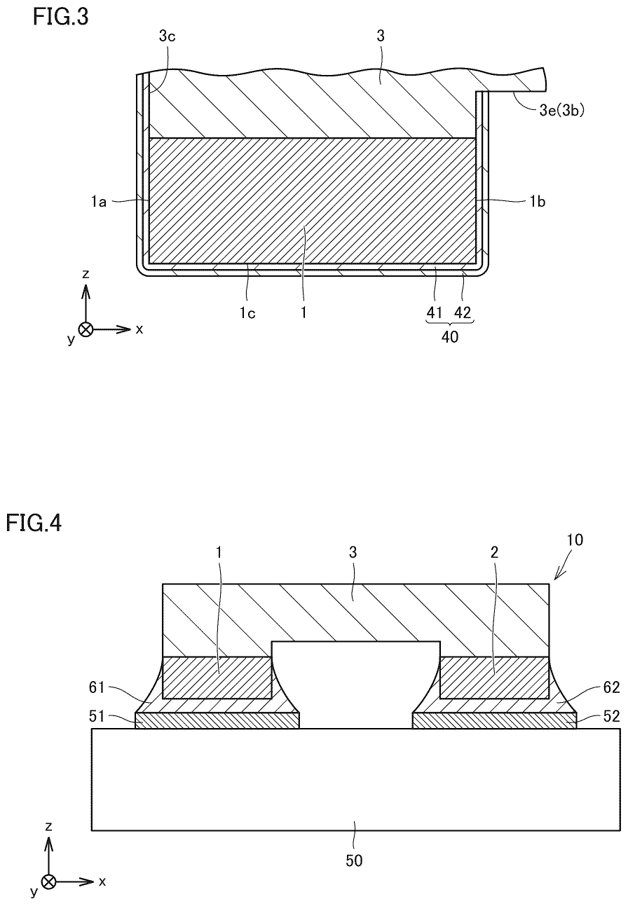

FIG. 1 is a schematic plan view illustrating a chip resistor according to a first embodiment. FIG. 2 is a schematic cross-sectional view taken along a line II-II of FIG. 1. FIG. 3 is an enlarged schematic cross-sectional view of a region III in FIG. 2.

As illustrated in FIGS. 1 to 3, a chip resistor 10 mainly includes a first electrode layer 1, a second electrode layer 2, and a resistor body 3. The chip resistor 10 is, for example, a shunt resistor. The resistor body 3 includes a first main surface 3a, a second main surface 3b, a first side surface 3c, and a second side surface 3d. The first main surface 3a is a flat surface. The second main surface 3b is located opposite to the first main surface 3a. The first side surface 3c is connected to the first main surface 3a and the second main surface 3b. The second side surface 3d is located opposite to the first side surface 3c. FIG. 1 is a schematic view of the chip resistor 10 viewed from the second main surface 3b (back surface) of the resistor body 3. In the present specification, the direction from the first side surface 3c toward the second side surface 3d of the resistor body 3 is defined as the x direction, the direction perpendicular to the x direction and along the first main surface 3a is defined as the y direction, and the direction perpendicular to the x direction and the y direction and from the second main surface 3b toward the first main surface 3a is defined as the z direction.

The resistor body 3 has a quadrangular planar shape. In the resistor body 3, a first length RL1 of the resistor body 3 in the first direction, i.e., the x direction, which is the direction from the first side surface 3c toward the second side surface 3d is equal to or longer than a second length RL2 in the second direction, i.e., the y direction, which is the direction perpendicular to the first direction and along the first main surface 3a. The first length RL1 is, for example, 20 mm or less. The first length RL1 may be 70 mm or less, 60 mm or less, or 50 mm or less. As illustrated in FIG. 1, the resistor body 3 has a rectangular planar shape. The resistor body 3 may have any other shape such as an oval shape or a long hole shape.

The first electrode layer 1 is connected to a first end 3ba of the second main surface 3b on the side of the first side surface 3c. As illustrated in FIG. 1, the first electrode layer 1 has a quadrangular planar shape. As illustrated in FIG. 2, a first outer peripheral side surface 1a of the first electrode layer 1 is substantially flush with the first side surface 3c of the resistor body 3. In other words, the protruding length of the first electrode layer 1 from the first side surface 3c is 0 in a plan view viewed from a direction perpendicular to the first main surface 3a.

The first electrode layer 1 includes a first inner peripheral side surface 1b facing the second electrode layer 2. An angle θ1 formed by the first inner peripheral side surface 1b and the second main surface 3b is 90° or more and 135° or less. The angle θ1 may be 130° or less, or 120° or less. The angle θ1 may be 92° or more, or 100° or more. The angle θ1 is, for example, 90°.

The side surfaces of the first electrode layer 1 connected to the resistor body 3 other than the first inner peripheral side surface 1b are substantially flush with the surfaces (the first side surface 3c and a set of side surfaces connecting the first side surface 3c and the second side surface 3d) of the resistor body 3.

The second electrode layer 2 is connected to a second end 3bb of the second main surface 3b on the side of the second side surface 3d. The second electrode layer 2 is spaced apart from the first electrode layer 1 by the first interval L1. As illustrated in FIG. 1, the second electrode layer 2 has a quadrangular planar shape. As illustrated in FIG. 2, a second outer peripheral side surface 2a of the second electrode layer 2 is substantially flush with the second side surface 3d of the resistor body 3. In other words, the protruding length of the second electrode layer 2 from the second side surface 3d is 0 in a plan view viewed from a direction perpendicular to the first main surface 3a.

The second electrode layer 2 includes a second inner peripheral side surface 2b facing the first electrode layer 1. An angle θ2 formed by the second inner peripheral side surface 2b and the second main surface 3b is 90° or more and 135° or less. The angle θ2 may be 130° or less, or 120° or less. The angle θ2 may be 92° or more, or 100° or more. The angle θ2 is, for example, 90°. The angle θ1 and the angle θ2 may be the same or different.

The first electrode layer 1 and the second electrode layer 2 may protrude from the side surface of the resistor body 3 to some extent in a plan view viewed from a direction perpendicular to the first main surface 3a. For example, in the plan view, the protruding length of the first electrode layer 1 from the first side surface 3c may be 0 mm or more and equal to or less than 0.5 times the first interval L1. Regarding the other side surface of the first electrode layer 1, the protruding length of the first electrode layer 1 from the side surface of the resistor body 3 may be 0 mm or more and equal to or less than 0.5 times the first interval L1 in the plan view. Further, in the plan view, the protruding length of the second electrode layer 2 from the second side surface 3d may be 0 mm or more and equal to or less than 0.5 times the first interval L1. Regarding the other side surface of the second electrode layer 2, the protruding length of the second electrode layer 2 from the side surface of the resistor body 3 may be 0 mm or more and equal to or less than 0.5 times the first interval L1 in the plan view.

As illustrated in FIG. 2, a recess 3e is formed on the second main surface 3b in a region between the first electrode layer 1 and the second electrode layer 2. The recess 3e on the second main surface 3b of the resistor body 3 is recessed from the first end 3ba and the second end 3bb toward the first main surface 3a. As illustrated in FIG. 2, the recess 3e is formed in the entire region between the first electrode layer 1 and the second electrode layer 2. The recess 3e may be formed only in a part of the region between the first electrode layer 1 and the second electrode layer 2.

As illustrated in FIG. 3, a coating layer 40 may be formed on a surface of the first electrode layer 1. The coating layer 40 may be a laminate including a plurality of layers. The coating layer 40 illustrated in FIG. 3 includes a first coating layer 41 formed to cover the surface of the first electrode layer 1, and a second coating layer 42 formed to cover the first coating layer 41. The material constituting the coating layer 40 may include nickel (Ni) or tin (Sn). For example, the material forming the first coating layer 41 may include nickel, and the material forming the second coating layer 42 may include tin.

All of the resistor body 3, the first electrode layer 1 and the second electrode layer 2 may be made of metal. For example, the material constituting the resistor body 3 may be a copper manganese (CuMn) alloy, a copper nickel (CuNi) alloy, a nickel chromium (NiCr) alloy, or the like. The material constituting the first electrode layer 1 or the second electrode layer 2 may be copper (Cu) or a copper alloy, for example.

A junction 4 between the resistor body 3 and the first electrode layer 1 is a first alloy portion 11 in which the metal constituting the resistor body 3 and the metal constituting the first electrode layer 1 are metal-bonded. A junction 5 between the resistor body 3 and the second electrode layer 2 is a second alloy portion 12 in which the metal constituting the resistor body 3 and the metal constituting the second electrode layer 2 are metal-bonded.

### <Configuration of Electronic Device Including Chip Resistor>

FIG. 4 is a partial cross-sectional schematic view illustrating an electronic device including the chip resistor 10 illustrated in FIG. 1. As illustrated in FIG. 4, the electronic device mainly includes a substrate 50 and the chip resistor 10 mounted on a surface of the substrate. The surface of the substrate 50 is formed with two conductive patterns 51 and 52. The two conductive patterns 51 and 52 are spaced apart from each other. The conductive patterns 51 and 52 are all made of metal such as copper or a copper alloy. The conductive patterns 51 and 52 are a part of a circuit mounted on the substrate 50.

The first electrode layer 1 of the chip resistor 10 is disposed on the conductive pattern 51. The first electrode layer 1 and the conductive pattern 51 are electrically and mechanically connected to each other by using a bonding material such as a solder 61. The planar size of the conductive pattern 51 is larger than the planar size of the first electrode layer 1 in a plan view viewed from a direction perpendicular to the first main surface 3a of the resistor body 3 of the chip resistor 10.

The second electrode layer 2 and the conductive pattern 52 are electrically and mechanically connected to each other by using a bonding material such as a solder 62. In the plan view, the planar size of the conductive pattern 52 is larger than the planar size of the second electrode layer 2. Each of the solders 61 and 62 includes a so-called fillet portion, which is a curved portion with a curved side surface (a curved convex toward the conductive patterns 51 and 52).

The electronic device illustrated in FIG. 4 is, for example, an electronic device for a battery or an automobile. The electronic device for an automobile may be an ECU (Electronic Control Unit), a vehicle ADAS (Advanced Driver-Assistance System), or the like.

### <Method of Manufacturing Chip Resistor>

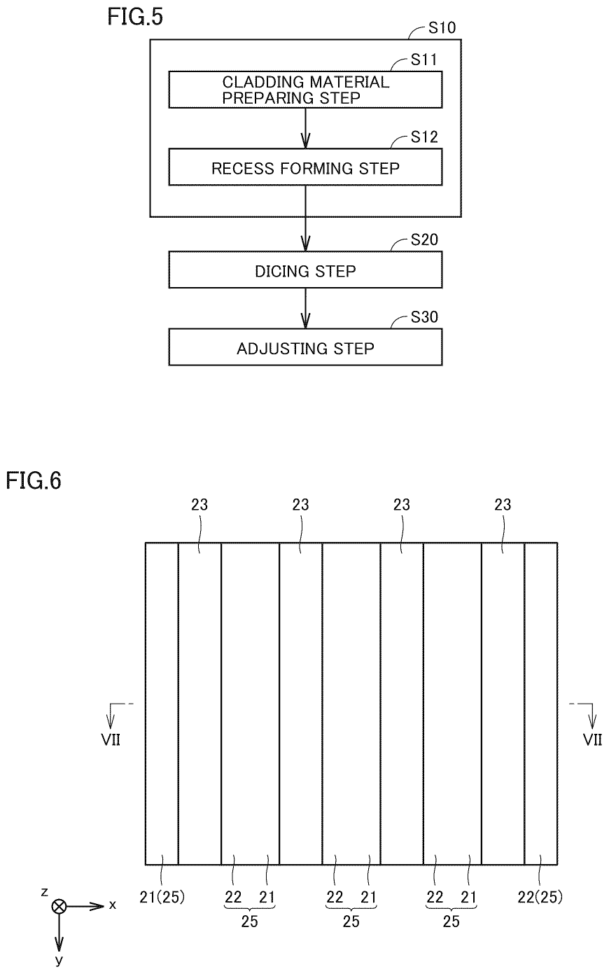

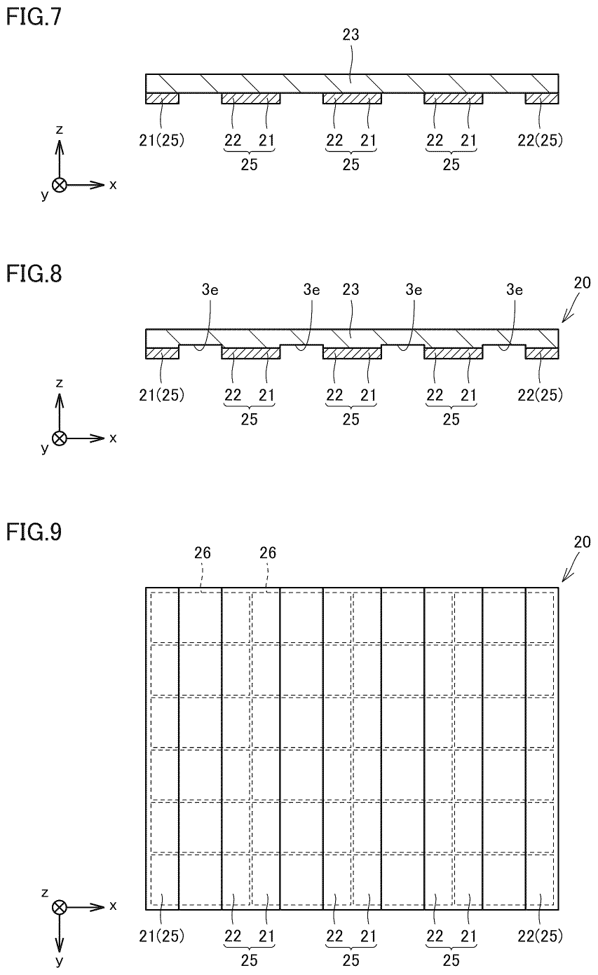

FIG. 5 is a flowchart illustrating a method of manufacturing the chip resistor illustrated in FIG. 1. FIG. 6 is a schematic view illustrating the method of manufacturing the chip resistor illustrated in FIG. 5. FIG. 7 is a schematic cross-sectional view taken along a line VII-VII in FIG. 6. FIG. 8 is a schematic cross-sectional view illustrating the method of manufacturing the chip resistor illustrated in FIG. 5. FIG. 9 is a schematic view illustrating the method of manufacturing the chip resistor illustrated in FIG. 5.

As illustrated in FIG. 5, in the method of manufacturing the chip resistor 10, firstly, a step (S10) of preparing a workpiece 20 (see FIG. 8) is performed. This step (S10) includes a step of preparing a cladding material (S11) and a step of forming a recess (S12). In the step of preparing the cladding material (S11), as illustrated in FIG. 6, a cladding material is prepared by bonding the conductive member 25 to the resistor base material 23.

The resistor base material 23 is a plate member for forming the resistor body 3 constituting the chip resistor 10. The resistor base material 23 has, for example, a quadrangular planar shape. The conductive member 25 is bonded to the surface of the resistor base material 23, and is made of a conductor. The conductive member 25 has a rectangular shape or a belt shape in a plan view. A plurality of conductive members 25 are bonded to the surface of the resistor base material 23. The plurality of conductive members 25 are spaced apart from each other. The plurality of conductive members 25 are arranged in parallel, extending in the same direction. The conductive member 25 is a member in which the first electrode member 21 and the second electrode member 22 are integrated. More specifically, the conductive member 25 is a member in which the belt-like first electrode member 21 and the belt-like second electrode member 22 are arranged in parallel and integrated. In the cladding material illustrated in FIGS. 6 and 7, the conductive member 25 disposed at one end includes only the first electrode member 21, and the conductive member 25 disposed at the other end includes only the second electrode member 22.

The first electrode member 21 is a conductive member for forming the first electrode layer 1 constituting the chip resistor 10. The second electrode member 22 is a conductive member for forming the second electrode layer 2 constituting the chip resistor 10. The second electrode member 22 of one conductive member 25 is disposed to face the first electrode member 21 of another adjacent conductive member 25 at an interval. The second electrode member 22 is disposed to extend along the first electrode member 21.

The resistor base material 23 and the conductive member 25 are all made of metal. The junction between the resistor base material 23 and the conductive member 25 is an alloy portion in which the metal constituting the resistor base material 23 and the metal constituting the conductive member 25 are metal-bonded. In other words, the resistor base material 23 and the first electrode member 21 are bonded to each other by metal-bonding the metal constituting the resistor base material 23 and the metal constituting the first electrode member 21. The resistor base material 23 and the second electrode member 22 are bonded to each other by metal-bonding the metal constituting the resistor base material 23 and the metal constituting the second electrode member 22.

The cladding material as illustrated in FIGS. 6 and 7 may be obtained by the following method, for example. First, a cladding base material is prepared by intermetallically bonding a conductive layer for forming the conductive member 25 to the entire surface (one main surface) of the resistor base material 23. Next, the conductor layer of the cladding base material is partially removed by etching or machining to obtain the cladding material as illustrated in FIGS. 6 and 7.

Next, in the step of forming a recess (S12), the surface of the resistor base material 23 exposed between the conductive members 25 on the surface of the cladding material to which the conductive members 25 are bonded is partially removed. In other words, in the step (S12), a region on the surface of the resistor base material 23 between the first electrode member 21 of one conductive member 25 and the second electrode member 22 of another adjacent conductive member 25 is partially removed to form the recess 3e.

As a result, as illustrated in FIG. 8, the recess 3e is formed on the surface of the resistor base material 23 in a region between the plurality of conductive members 25. In this way, the workpiece 20 illustrated in FIG. 8 is obtained. As a method of partially removing the resistor base material 23 to form the recess 3e, any method such as mechanical machining (for example, cutting or milling), laser machining or etching may be used.

As illustrated in FIG. 7, the workpiece 20 includes a conductive member 25 including a first electrode member 21 and a second electrode member 22, and a resistor base material 23.

Next, a dicing step (S20) is performed. In this step (S20), as illustrated in FIG. 9, the workpiece 20 is press-cut or otherwise mechanically machined to cut off a portion indicated by the cut line 26 to obtain the chip resistor 10. Any mechanical machining method such as punching or shearing may be used in the step S20.

Next, an adjusting step (S30) is performed. In this step (S30), the electric resistance value of each diced chip resistor 10 is adjusted by partially removing the surface of the recess 3e (see FIG. 8) of each diced chip resistor 10. Thus, the chip resistor 10 illustrated in FIGS. 1 to 3 is obtained.

In the step S30, as a method of removing (trimming) the surface of the recess 3e, any method such as mechanical machining (for example, cutting) or laser machining may be used. In the step S30, the surface of the recess 3e may be removed while the electric resistance value of the chip resistor 10 is being measured. In this case, it is possible to obtain the chip resistor 10 with an electrical resistance value controlled with high accuracy. The step S20 and the step S30 described above correspond to the step of forming the chip resistor 10.

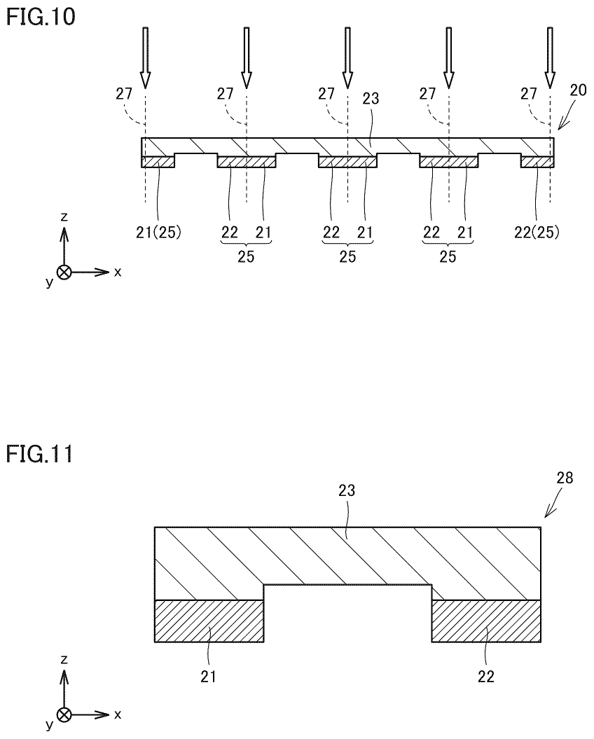

In the dicing step (S20), first, the workpiece 20 may be cut off along the cutting line 27 as illustrated in FIG. 10 to form a workpiece 28 extending in a belt shape as illustrated in FIG. 11. In the step illustrated in FIG. 10, the workpiece 20 is cut off from the side of the resistor base material 23 as indicated by arrows. The workpiece 28 illustrated in FIG. 11 has a belt shape extending in a direction perpendicular to the paper surface (y direction). Thereafter, the belt-like workpiece 28 may be cut off at regular intervals in the extending direction (y direction in FIG. 11) of the workpiece 28, whereby the workpiece 28 may be diced into individual pieces to obtain the chip resistor 10. Further, at this time, the resistance value of the chip resistor 10 may be modified by appropriately selecting the cutting position of the workpiece 28 so as to adjust the width (the second length RL2 in FIG. 1) of the chip resistor 10 which is obtained by cutting the workpiece 28.

### <Function and Effects>

As illustrated in FIGS. 1 to 3, the chip resistor 10 according to the present disclosure includes a first electrode layer 1, a second electrode layer 2, and a resistor body 3. The resistor body 3 includes a first main surface 3a, a second main surface 3b, a first side surface 3c, and a second side surface 3d. The second main surface 3b is located opposite to the first main surface 3a. The first side surface 3c is connected to the first main surface 3a and the second main surface 3b. The second side surface 3d is located opposite to the first side surface 3c. The first electrode layer 1 is connected to the first end 3ba of the second main surface 3b on the side of the first side surface 3c. The second electrode layer 2 is connected to the second end 3bb of the second main surface 3b on the side of the second side surface 3d. The second electrode layer 2 is spaced apart from the first electrode layer 1 by a first interval L1. In a plan view viewed from a direction perpendicular to the first main surface 3a, a protruding length L2 of the first electrode layer 1 from the first side surface 3c is 0 mm or more and equal to or less than 0.5 times the first interval L1.

In this way, the first electrode layer 1 and the second electrode layer 2 are electrically and mechanically connected to the second main surface 3b of the resistor body 3, which makes it possible to reduce the size of the chip resistor 10 smaller than a conventional chip resistor where the first electrode layer 1 and the second electrode layer 2 are bonded to the first side surface 3c and the second side surface 3d of the resistor body 3, respectively. Further, since the protruding length L2 of the first electrode layer 1 from the first side surface 3c of the resistor body 3 is set sufficiently small, it also contributes to reducing the size of the chip resistor 10. Therefore, as illustrated in FIG. 4, it is possible to reduce the size of the electronic device which is obtained by mounting the chip resistor 10 on the substrate 50.

Further, since the first electrode layer 1 and the second electrode layer 2 are connected to the second main surface 3b of the resistor body 3, it is possible to easily increase the bonding area between the electrode and the resistor body 3 as compared with the conventional case where the electrodes are connected to the first side surface 3c and the second side surface 3d (the end surfaces) of the resistor body 3 by welding or the like. Therefore, it is possible to suppress the occurrence of a problem such as poor connection between the resistor body 3 and the electrode.

In the chip resistor 10, the first electrode layer 1 may include a first inner peripheral side surface 1b facing the second electrode layer 2. An angle θ1 formed by the first inner peripheral side surface 1b and the second main surface 3b may be equal to or greater than 30° and equal to or less than 95°.

In this case, when the first electrode layer 1 is bonded to the conductive pattern 51 of the substrate 50 by using a bonding material such as the solder 61, it is possible to relatively increase the area of the bottom surface of the first electrode layer 1 facing the conductive pattern 51. Therefore, since the contact area between the first electrode layer 1 and the solder 61 is relatively increased, it is possible to improve the bonding strength between the first electrode layer 1 and the conductive pattern 51.

The second electrode layer 2 may include a second inner peripheral side surface 2b facing the first electrode layer 1. An angle θ2 formed by the second inner peripheral side surface 2b and the second main surface 3b may be equal to or greater than 30° and equal to or less than 95°. The angle θ1 and the angle θ2 may be the same or different.

Thus, similar to the first electrode layer 1, it is possible to relatively increase the area of the bottom surface of the second electrode layer 2 facing the conductive pattern 52. Since the contact area between the second electrode layer 2 and the solder 62 can be relatively increased, it is possible to improve the bonding strength between the second electrode layer 2 and the conductive pattern 52.

In the chip resistor 10, a recess 3e may be formed on the second main surface 3b in a region between the first electrode layer 1 and the second electrode layer 2. Since the recess 3e is formed on the second main surface 3b of the resistor body 3 between the first electrode layer 1 and the second electrode layer 2, a part of the resistor body 3 is removed by cutting or the like. Therefore, even if a conductor that may short-circuit the first electrode layer 1 and the second electrode layer 2 was formed on the second main surface 3b, the conductor is removed in the step of forming the recess 3e. As a result, the first electrode layer 1 and the second electrode layer 2 may be reliably insulated from each other.

In the chip resistor 10, the first main surface 3a may be a flat surface. Thus, when the resistance value of the chip resistor 10 is adjusted by partially removing a surface other than the first main surface 3a such as the second main surface 3b of the resistor body 3, it is possible to adjust the resistance value with higher precision than the case where the first main surface 3a is not a flat surface.

In the chip resistor 10, all of the resistor body 3, the first electrode layer 1 and the second electrode layer 2 may be made of metal. The junction 4 between the resistor body 3 and the first electrode layer 1 may be a first alloy portion 11 in which the metal constituting the resistor body 3 and the metal constituting the first electrode layer 1 are metal-bonded. The junction 5 between the resistor body 3 and the second electrode layer 2 may be a second alloy portion 12 in which the metal constituting the resistor body 3 and the metal constituting the second electrode layer 2 are metal-bonded.

In this case, it is possible to reduce the size of the chip resistor 10 as compared with the case where the resistor body 3 and the first electrode layer 1 and the second electrode layer 2 are bonded to each other by using a bonding material such as a solder. Further, since the junction 4 or 5 is formed by the first alloy portion 11 or the second alloy portion 12, it is possible to improve the bonding strength between the first electrode layer 1 or the second electrode layer 2 and the resistor body 3 as compared with the case of using a bonding material such as a solder.

In the chip resistor 10, the first length RL1 of the resistor body 3 in the first direction (x direction) which is a direction from the first side surface 3c toward the second side surface 3d may be equal to or longer than the second length RL2 of the resistor body 3 in the second direction (y direction) which is a direction perpendicular to the first direction and along the first main surface 3a.

Thus, the distance (insulating distance) between the first electrode layer 1 and the second electrode layer 2 can be sufficiently ensured.

In the chip resistor 10, the first length RL1 may be 20 mm or less. Thus, the chip resistor 10 can be made sufficiently small.

The chip resistor 10 may be a shunt resistor. Thus, the shunt resistor can be made small in size.

An electronic device according to the present disclosure includes a substrate 50 and the chip resistor 10. The chip resistor 10 is mounted on the substrate 50. Thus, the size of the electronic device can be reduced.

The method of manufacturing a chip resistor 10 according to the present disclosure includes a step of preparing the workpiece 20 (S10), and a step of forming the chip resistor 10 (S20, S30). In the preparing step (S10), the workpiece 20 is prepared. The workpiece 20 includes a first electrode member 21, a second electrode member 22, and a resistor base material 23. The resistor base material 23 is a plate member for forming the resistor body 3 constituting the chip resistor 10. The first electrode member 21 is a conductive member for forming the first electrode layer 1 constituting the chip resistor 10. The first electrode member 21 is connected to a surface of the resistor base material 23. The first electrode member 21 has a belt-like planar shape when viewed from a direction perpendicular to the surface of the resistor base material 23. The second electrode member 22 is a conductive member for forming the second electrode layer 2 constituting the chip resistor 10. The second electrode member 22 is connected to the surface of the resistor base material 23. The second electrode member 22 is spaced apart from the first electrode member 21. The second electrode member 22 has a belt-like planar shape when viewed from a direction perpendicular to the surface, and is disposed to extend along the first electrode member 21. In the step (S20, S30) of forming the chip resistor 10, the workpiece 20 is diced to form a chip resistor 10. As illustrated in FIGS. 1 to 3, the chip resistor 10 includes a resistor body 3, a first electrode layer 1, and a second electrode layer 2. In the chip resistor 10, the resistor body 3 includes a first main surface 3a, a second main surface 3b, a first side surface 3c, and a second side surface 3d. The second main surface 3b is located opposite to the first main surface 3a. The first side surface 3c is connected to the first main surface 3a and the second main surface 3b. The second side surface 3d is located opposite to the first side surface 3c. The first electrode layer 1 is connected to the first end 3ba of the second main surface 3b on the side of the first side surface 3c. The second electrode layer 2 is connected to the second end 3bb of the second main surface 3b on the side of the second side surface 3d. The second electrode layer 2 is spaced apart from the first electrode layer 1 by a first interval L1. In a plan view viewed from a direction perpendicular to the first main surface 3a, the protruding length L2 of the first electrode layer 1 from the first side surface 3c is 0 mm or more and equal to or less than 0.5 times the first interval L1.

Thus, the chip resistor 10 according to the present embodiment can be obtained.

In the method of manufacturing the chip resistor, in the preparing step (S10), all of the resistor base material 23, the first electrode member 21 and the second electrode member 22 may be made of metal. The resistor base material 23 and the first electrode member 21 may be bonded to each other by metal-bonding the metal constituting the resistor base material 23 and the metal constituting the first electrode member 21. The resistor base material 23 and the second electrode member 22 may be bonded to each other by metal-bonding the metal constituting the resistor base material 23 and the metal constituting the second electrode member 22.

In this way, the bonding strength between the resistor base material 23 and the first electrode member 21 and the second electrode member 22 can be improved.

In the method of manufacturing the chip resistor, the preparing step (S10) may include a step (S12) of forming a recess 3e. In the step (S12) of forming a recess, the recess 3e may be formed by partially removing a region on the surface of the resistor base material 23 between the first electrode member 21 and the second electrode member 22.

Since the recess 3e is formed, a substance such as a conductive film that may short-circuit the first electrode member 21 and the second electrode member 22 can be reliably removed from the region between the first electrode member 21 and the second electrode member 22. Therefore, it is possible to reduce the possibility that the first electrode member 21 and the second electrode member 22 are short-circuited.

### <Modification>

FIG. 12 is a schematic cross-sectional view illustrating a first modification of the chip resistor 10 illustrated in FIG. 1. The chip resistor 10 illustrated in FIG. 12 basically has the same configuration as the chip resistor 10 illustrated in FIGS. 1 to 3 and can obtain the same effects, but is different from the chip resistor 10 illustrated in FIGS. 1 to 3 in the shape of the first electrode layer 1, the shape of the second electrode layer 2 and the shape of the recess 3e of the resistor body 3.

Specifically, in the chip resistor 10 illustrated in FIG. 12, the first electrode layer 1 and the second electrode layer 2 each include a curved portion 31 in a region opposed to each other. The first inner peripheral side surface 1b of the first electrode layer 1 and the second inner peripheral side surface 2b of the second electrode layer 2 correspond to the curved portions 31, respectively. The surface of the recess 3e is also curved. The curved portion 31 of the first electrode layer 1, the recess 3e of the resistor body 3, and the curved portion 31 of the second electrode layer 2 form one smoothly continuous curved surface.

Thus, it is possible to increase the surface area of the first electrode layer 1 and the second electrode layer 2 larger than the case where the surface of the first electrode layer 1 and the surface of the second electrode layer 2 (specifically, the first inner peripheral side surface 1b and the second inner peripheral side surface 2b) are planar. Therefore, when the first electrode layer 1 and the second electrode layer 2 are connected to the conductive patterns 51 and 52 (see FIG. 4) by the bonding materials such as the solders 61 and 62 (see FIG. 4), it is possible to increase the bonding area between the first electrode layer 1 and the solder 61 and the bonding area between the second electrode layer 2 and the solder 62. As a result, it is possible to improve the bonding strength between the first electrode layer 1 and the solder 61 and the bonding strength between the second electrode layer 2 and the solder 62.

In the chip resistor 10 illustrated in FIG. 12, a step may be formed at the boundary between the curved portion 31 of the first electrode layer 1 and the recess 3e of the resistor body 3, and a step may be formed at the boundary between the curved portion 31 of the second electrode layer 2 and the recess 3e of the resistor body 3. Further, if the curved portion 31 of the first electrode layer 1 and the curved portion 31 of the second electrode layer 2 are both curved, a portion of the inner peripheral surface of the recess 3e of the resistor body 3 may be planar, and for example, the entire inner peripheral surface of the recess 3e may be planar.

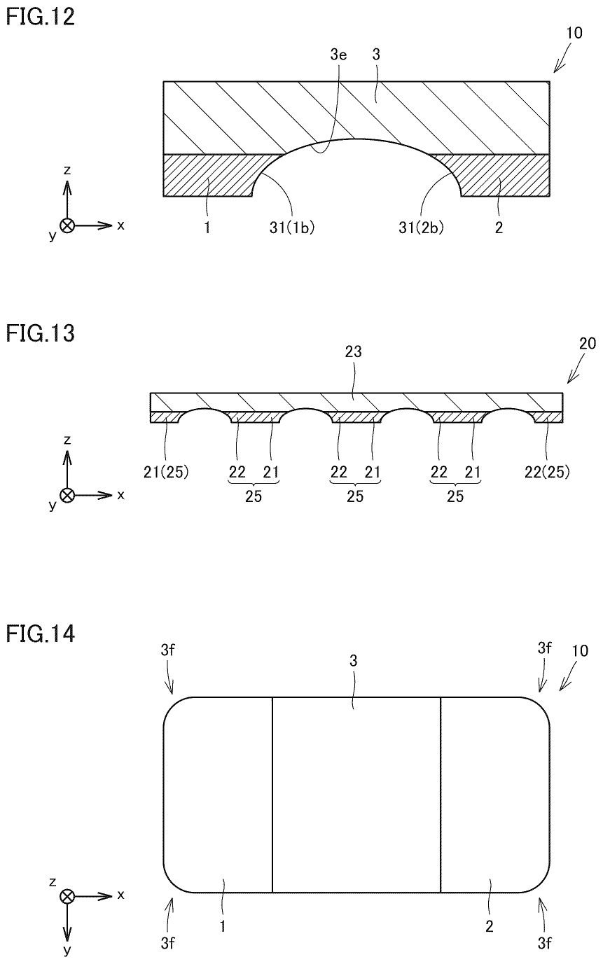

Although the method of manufacturing the chip resistor 10 illustrated in FIG. 12 is basically the same as the method of manufacturing the chip resistor 10 illustrated in FIGS. 1 to 3, but is different from the method of manufacturing the chip resistor 10 illustrated in FIGS. 1 to 3 in the step (S10) of preparing a workpiece 20. Specifically, in the above step (S10), a workpiece 20 as illustrated in FIG. 13 is prepared.

FIG. 13 is a schematic cross-sectional view illustrating the method of manufacturing the chip resistor illustrated in FIG. 12, and corresponds to FIG. 8. The workpiece 20 illustrated in FIG. 13 basically has the same configuration as the workpiece 20 illustrated in FIG. 8, but is different from the workpiece 20 illustrated in FIG. 8 in the shape of each region between the plurality of conductive members 25 in the workpiece 20. In other words, in the workpiece 20 illustrated in FIG. 13, the side surface of each of the plurality of conductive member 25 and the surface of the resistor base material 23 exposed between the plurality of conductive members 25 form a recess with a smoothly continuous curved surface.

This workpiece 20 can be obtained, for example, by the following steps. First, a cladding base material is prepared by intermetallically bonding a conductive layer for forming the conductive member 25 to the entire surface (one main surface) of the resistor base material 23. Next, the conductor layer of the cladding base material is partially removed by wet-etching or the like to obtain the cladding material as illustrated in FIG. 13.

FIG. 14 is a schematic plan view illustrating a second modification of the chip resistor illustrated in FIG. 1. The chip resistor 10 illustrated in FIG. 14 basically has the same configuration as the chip resistor 10 illustrated in FIGS. 1 to 3 and can obtain the same effects, but is different from the chip resistor 10 illustrated in FIGS. 1 to 3 in the planar shape of the first electrode layer 1, the planar shape of the second electrode layer 2, and the planar shape of the resistor body 3.

Specifically, in the chip resistor 10 illustrated in FIG. 14, each corner portion 3f of the resistor body 3 in the plan view is curved. In the plan view, the corner portions of the first electrode layer 1 and the second electrode layer 2, which overlap the corner portions 3f of the resistor body 3, are also curved.

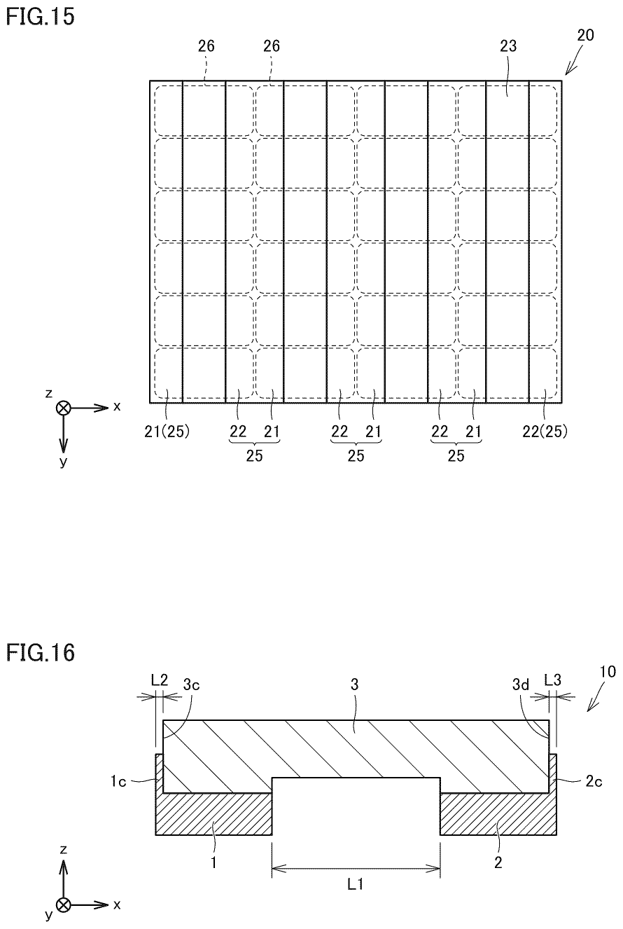

The method of manufacturing the chip resistor 10 illustrated in FIG. 14 is basically the same as the method of manufacturing the chip resistor 10 illustrated in FIGS. 1 to 3, but is different from the method of manufacturing the chip resistor 10 illustrated in FIGS. 1 to 3 in the dicing step (S20). Specifically, as illustrated in FIG. 15, in the dicing step (S20), the shape of the cutting line 26 when the chip resistor 10 is cut from the workpiece 20 by punch press is a square with round corners. FIG. 15 is a schematic view illustrating the method of manufacturing the chip resistor illustrated in FIG. 14. FIG. 15 corresponds to FIG. 9. The shape of the cutting line 26 corresponds to the planar shape of the chip resistor 10 illustrated in FIG. 14. With such a shape of the cutting line 26, a local load concentrated on the mold in the punch press can be suppressed, resulting in suppressing the occurrence of problems such as processing defects.

### Second Embodiment

### <Configuration of Chip Resistor>

FIG. 16 is a schematic cross-sectional view illustrating a chip resistor according to a second embodiment. The chip resistor 10 illustrated in FIG. 16 basically has the same configuration as the chip resistor 10 illustrated in FIGS. 1 to 3 and can obtain the same effects, but is different from the chip resistor 10 illustrated in FIGS. 1 to 3 in the shape of the first electrode layer 1 and the shape of the second electrode layer 2.

Specifically, in the chip resistor 10 illustrated in FIG. 16, a portion 1c of the first outer peripheral side surface 1a of the first electrode layer 1 is disposed to cover a portion of the first side surface 3c of the resistor body 3. A portion 2c of the second outer peripheral side surface 2a of the second electrode layer 2 is disposed to cover a portion of the second side surface 3d of the resistor body 3. The distance from the second main surface 3b of the resistor body 3 to the top surface of the portion 1c of the first electrode layer 1 is smaller than the distance from the second main surface 3b of the resistor body 3 to the first main surface 3a. In other words, the top surface of the portion 1c of the first electrode layer 1 is located at a position lower than the first main surface 3a of the resistor body 3 (on the side of the second main surface 3b). In a plan view viewed from a direction perpendicular to the first main surface 3a, the thickness of the portion 1c corresponding to the protruding length L2 of the first electrode layer 1 from the first side surface 3c is equal to or less than 0.5 times the first interval L1. Preferably, the thickness of the portion 1c is 1 mm or less.

The distance from the second main surface 3b of the resistor body 3 to the top surface of the portion 2c of the second electrode layer 2 is smaller than the distance from the second main surface 3b of the resistor body 3 to the first main surface 3a. In other words, the top surface of the portion 2c of the second electrode layer 2 is positioned below the position of the first main surface 3a of the resistor body 3 (on the side of the second main surface 3b). In the plan view, the thickness of the portion 2c corresponding to a protruding length L3 of the second electrode layer 2 from the first side surface 3c is equal to or less than 0.5 times the first interval L1. Preferably, the thickness of the portion 2c is 1 mm or less. The thickness of the portion 1c of the first electrode layer 1 and the thickness of the portion 2c of the second electrode layer 2 may be the same or different.

### <Configuration of Electronic Device Including Chip Resistor>

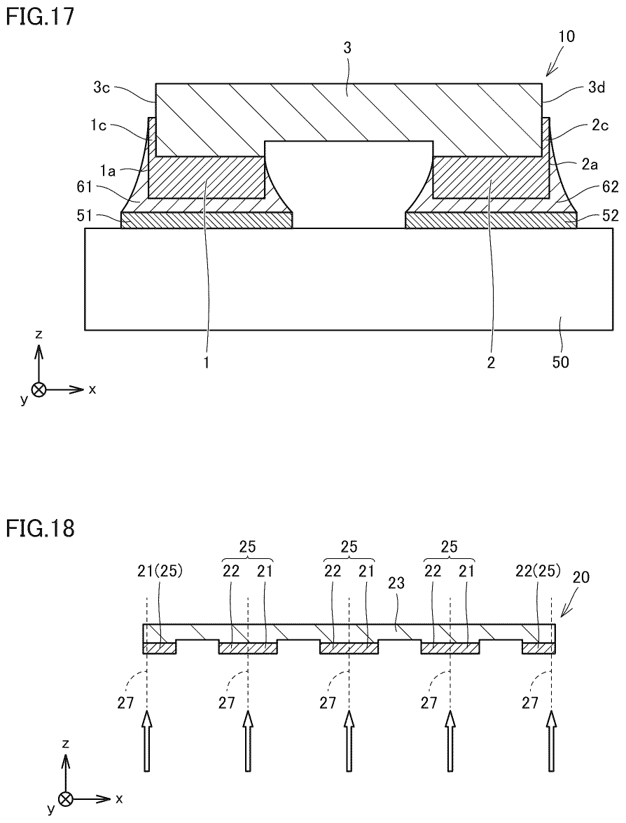

FIG. 17 is a partial cross-sectional schematic view illustrating a substrate on which the chip resistor illustrated in FIG. 16 is mounted. FIG. 17 corresponds to FIG. 4. The substrate on which the chip resistor 10 illustrated in FIG. 17 is mounted basically has the same configuration as the substrate illustrated in FIG. 4 and can obtain the same effects, but is different from the substrate illustrated in FIG. 4 in the configuration of the chip resistor 10 and the shape of the solders 61 and 62. In other words, in the substrate 50 on which the chip resistor 10 illustrated in FIG. 17 is mounted, the solders 61 and 62 that electrically and mechanically connect the chip resistor 10 to the substrate 50 can form a fillet larger than that formed by the solders 61 and 62 illustrated in FIG. 4. Since the solder 61 is connected to the portion 1c of the first electrode layer 1, the area of the connection interface between the solder 61 and the first electrode layer 1 can be made larger than the structure illustrated in FIG. 4. Further, since the solder 62 is connected to the portion 2c of the second electrode layer 2, the area of the connection interface between the solder 62 and the second electrode layer 2 can be made larger than the structure illustrated in FIG. 4.

### <Method of Manufacturing Chip Resistor>

FIG. 18 is a schematic view illustrating the method of manufacturing the chip resistor illustrated in FIG. 16. FIG. 18 corresponds to FIG. 10. The method of manufacturing the chip resistor 10 illustrated in FIG. 16 is basically the same as the method of manufacturing the chip resistor 10 illustrated in FIGS. 1 to 3, but is different from the method of manufacturing the chip resistor 10 illustrated in FIGS. 1 to 3 in the dicing step (S20). Specifically, in the step (S20), the workpiece 20 is cut along the cutting line 27 as illustrated in FIG. 18. At this time, the workpiece 20 is cut from the side of the conductive member 25 as indicated by an arrow. By adjusting the cutting conditions, the workpiece 20 can be cut in such a manner that a portion of the cut conductive member 25 remains on the cut surface of the resistor base material 23. For example, by adjusting the clearance of a mold (cutting tool) used in the punch press for cutting the workpiece 20, a portion of the conductive member 25 serving as the first electrode member 21 and the second electrode member 22 can extend on the cut surface of the resistor base material 23 as described above. In this way, it is possible to obtain a belt-like workpiece in which a portion of the conductive member 25 extends on the cut surface of the resistor base material 23.

Thereafter, the belt-like workpiece is cut at regular intervals in the extending direction (y direction in FIG. 18) of the workpiece, whereby the workpiece is diced into individual pieces to obtain the chip resistor 10 illustrated in FIG. 16.

### <Function and Effects>

In the chip resistor 10, the portion 1c of the first electrode layer 1 may be disposed to cover a portion of the first side surface 3c of the resistor body 3. The portion 2c of the second electrode layer 2 may be disposed to cover a portion of the second side surface 3d of the resistor body 3.

In this way, as illustrated in FIG. 17, when the first electrode layer 1 is bonded to the conductive pattern 51 of the substrate 50 by using a bonding material such as the solder 61, the solder 61 can spread over the portion 1c of the first electrode layer 1. Therefore, the solder 61 can be easily formed into a fillet shape. Therefore, the bonding strength between the first electrode layer 1 and the conductive pattern 51 can be improved. Also, in the case of the second electrode layer 2, the solder 62 can be easily formed into a fillet shape, and thereby, the bonding strength between the second electrode layer 2 and the conductive pattern 52 can be improved.

### Third Embodiment

### <Configuration of Chip Resistor>

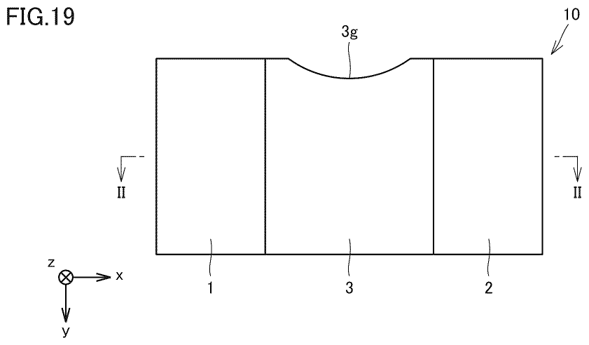

FIG. 19 is a schematic plan view illustrating a chip resistor according to a third embodiment. FIG. 19 corresponds to FIG. 1. The chip resistor 10 illustrated in FIG. 19 basically has the same configuration as the chip resistor 10 illustrated in FIGS. 1 to 3 and can obtain the same effects, but is different from the chip resistor 10 illustrated in FIGS. 1 to 3 in the shape of the resistor body 3.

Specifically, in the chip resistor 10 illustrated in FIG. 19, a recess 3g is formed on a side surface of the resistor body 3 located between the first electrode layer 1 and the second electrode layer 2. The inner peripheral surface of the recess 3g is curved. However, the inner peripheral surface of the recess 3g may be formed by a plurality of planes. In FIG. 19, only one recess 3g is formed, but the recess may be formed on both side surfaces of the resistor body 3 between the first electrode layer 1 and the second electrode layer 2.

### <Method of Manufacturing Chip Resistor>

The method of manufacturing the chip resistor 10 illustrated in FIG. 19 is basically the same as the method of manufacturing the chip resistor 10 illustrated in FIGS. 1 to 3, but is different from the method of manufacturing the chip resistor 10 illustrated in FIGS. 1 to 3 in the adjusting step (S30). Specifically, in the step (S30), a side surface of the resistor body 3 of each chip resistor 10 between the first electrode layer 1 and the second electrode layer 2 is partially removed. By forming the recess 3g (see FIG. 19), the electric resistance value of the chip resistor 10 is adjusted. Thus, the chip resistor 10 illustrated in FIG. 19 can be obtained.

### <Function and Effects>

In the chip resistor 10, a recess 3g may be formed on a side surface of the resistor body 3 located between the first electrode layer 1 and the second electrode layer 2. In this case, the width of the resistor body 3 in the y direction (see FIG. 19) can be changed by changing the size of the recess 3g. As a result, the electrical resistance value of the chip resistor 10 can be adjusted.

### Fourth Embodiment

### <Configuration and Effects of Chip Resistor>

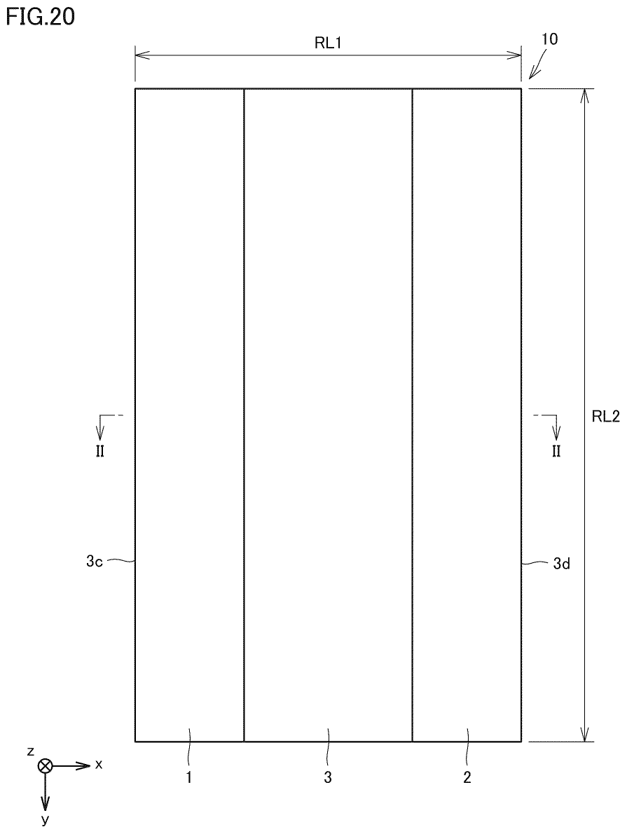

FIG. 20 is a schematic plan view illustrating a chip resistor according to a fourth embodiment. FIG. 20 corresponds to FIG. 1. A cross section of the chip resistor 10 FIG. 20 taken along a line II-II is illustrated in FIG. 2. The chip resistor 10 illustrated in FIG. 20 basically has the same configuration as the chip resistor 10 illustrated in FIGS. 1 to 3 and can obtain the same effects, but is different from the chip resistor 10 illustrated in FIGS. 1 to 3 in the shape of the resistor body 3.

Specifically, in the chip resistor 10 illustrated in FIG. 20, the first length RL1 of the resistor body 3 in the first direction (x direction), which is a direction from the first side surface 3c toward the second side surface 3d, is shorter than the second length RL2 of the resistor body 3 in the second direction (y direction), which is a direction perpendicular to the first direction and along the first main surface 3a (see FIG. 2).

In this way, since the cross-sectional area of the region to be energized in the resistor body 3 can be increased by increasing the second length RL2, it is possible to increase the value of a current flowing in the chip resistor 10.

### <Method of Manufacturing Chip Resistor>

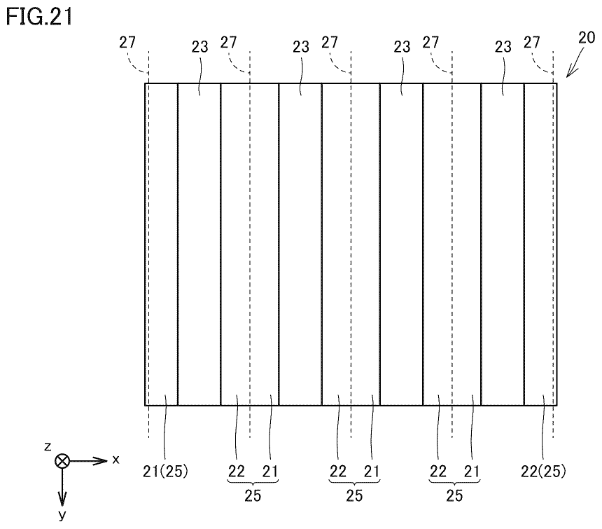

FIG. 21 is a schematic view illustrating the method of manufacturing the chip resistor illustrated in FIG. 20. The method of manufacturing the chip resistor 10 illustrated in FIG. 20 is basically the same as the method of manufacturing the chip resistor 10 illustrated in FIGS. 1 to 3, but is different from the method of manufacturing the chip resistor 10 illustrated in FIGS. 1 to 3 in the dicing step (S20). Specifically, as illustrated in FIG. 21, in the dicing step (S20), the shape of the cutting line 27 when the chip resistor 10 is cut from the workpiece 20 by shearing or the like is linear along the y direction. In FIG. 21, the width of the workpiece 20 in the y direction is the same as the second length RL2 in the second direction (y direction) of the chip resistor 10 illustrated in FIG. 20.

In the method of manufacturing the chip resistor 10 illustrated in FIG. 20, the step (S20) of dicing the chip resistor 10 illustrated in FIGS. 10 and 11 may be adopted. In this case, the belt-like workpiece 28 illustrated in FIG. 11 may be cut by each second length RL2 in FIG. 20 in the extending direction (y direction in FIG. 11) of the workpiece 28, whereby the workpiece 28 may be divided into individual pieces. Thus, the chip resistor 10 illustrated in FIG. 20 can be obtained.

It should be understood that the embodiments disclosed herein are illustrative and non-restrictive in all respects. Unless inconsistent, at least two of the embodiments disclosed herein may be combined. The scope of the present invention is defined by the terms of the claims rather than the description of the embodiments above, and is intended to include any modifications within the scope and meaning equivalent to the terms of the claims.

### REFERENCE SIGNS LIST

1: first electrode layer; 1a: first outer peripheral side surface; 1b: first inner peripheral side surface; 1c, 2c: portion; 2: second electrode layer; 2a: second outer peripheral side surface; 2b: second inner peripheral side surface; 3: resistor body; 3a: first main surface; 3b: second main surface; 3ba: first end; 3bb: second end; 3c: first side surface; 3d: second side surface; 3e, 3g: recess; 3f: corner; 4, 5: junction; 10: chip resistor; 11: first alloy portion; 12: second alloy portion; 20, 28: workpiece; 21: first electrode member; 22: second electrode member; 23: resistor base material; 25: conductive member; 26, 27: cutting line; 31: curved portion; 40: coating layer; 41: first coating layer; 42: second coating layer; 50: substrate; 51, 52: conductive pattern; 61, 62: solder

1. A chip resistor comprising:
a resistor body including a first main surface, a second main surface opposite to the first main surface, a first side surface connected to the first main surface and the second main surface, and a second side surface opposite to the first side surface;
a first electrode layer connected to a first end of the second main surface on the side of the first side surface; and
a second electrode layer connected to a second end of the second main surface on the side of the second side surface side and spaced apart from the first electrode layer by a first interval,
in a plan view viewed from a direction perpendicular to the first main surface, a protruding length of the first electrode layer from the first side surface is 0 mm or more and equal to or less than 0.5 times the first interval.

2. The chip resistor according to claim 1, wherein
the first electrode layer includes a first inner peripheral side surface facing the second electrode layer,
an angle formed by the first inner peripheral side surface and the second main surface is 90° or more and 135° or less.

3. The chip resistor according to claim 1, wherein a recess is formed on the second main surface in a region between the first electrode layer and the second electrode layer.

4. The chip resistor according to claim 1, wherein the first main surface is a flat surface.

5. The chip resistor according to claim 1, wherein
the resistor body, the first electrode layer, and the second electrode layer are all made of metal,
a junction between the resistor body and the first electrode layer is a first alloy portion in which a metal constituting the resistor body and a metal constituting the first electrode layer are metal-bonded, and
a junction between the resistor body and the second electrode layer is a second alloy portion in which a metal constituting the resistor body and a metal constituting the second electrode layer are metal-bonded.

6. The chip resistor according to claim 1, wherein a first length of the resistor body in a first direction, which is a direction from the first side surface toward the second side surface, is equal to or longer than a second length of the resistor body in a second direction, which is a direction perpendicular to the first direction and along the first main surface.

7. The chip resistor according to claim 1, wherein a first length of the resistor body in a first direction, which is a direction from the first side surface toward the second side surface, is shorter than a second length of the resistor body in a second direction, which is a direction perpendicular to the first direction and along the first main surface.

8. The chip resistor according to claim 6, wherein the first length is 20 mm or less.

9. The chip resistor according to claim 1, wherein the first electrode layer and the second electrode layer each include a curved portion in a region opposed to each other.

10. The chip resistor according to claim 1, wherein
a portion of the first electrode layer is disposed to cover a portion of the first side surface of the resistor body, and
a portion of the second electrode layer is disposed to cover a portion of the second side surface of the resistor body.

11. The chip resistor according to claim 1, wherein the chip resistor is a shunt resistor.

12. A method of manufacturing a chip resistor comprising:
a step of preparing a workpiece that includes a resistor base material, a first electrode member, and a second electrode member,
the resistor base material is a plate member for forming a resistor body constituting a chip resistor,
the first electrode member is a conductive member for forming a first electrode layer constituting the chip resistor, is connected to a surface of the resistor base material, and has a belt-like planar shape when viewed from a direction perpendicular to the surface,
the second electrode member is a conductive member for forming a second electrode layer constituting the chip resistor, is connected to the surface of the resistor base material, and is spaced apart from the first electrode member,
the second electrode member has a belt-like planar shape when viewed from the direction perpendicular to the surface, and is disposed to extend along the first electrode member, the method further comprising:
a step of forming the chip resistor including the resistor body, the first electrode layer, and the second electrode layer by dicing the workpiece,
in the chip resistor,
the resistor body includes a first main surface, a second main surface opposite to the first main surface, a first side surface connected to the first main surface and the second main surface, and a second side surface opposite to the first side surface,
the first electrode layer is connected to a first end of the second main surface on the side of the first side surface,
the second electrode layer is connected to a second end of the second main surface on the side of the second side surface, and is spaced apart from the first electrode layer by a first interval,
in a plan view viewed from a direction perpendicular to the first main surface, a protruding length of the first electrode layer from the first side surface is 0 mm or more and equal to or less than 0.5 times the first interval.

13. The method of manufacturing a chip resistor according to claim 12, wherein
in the preparing step, the resistor base material, the first electrode member, and the second electrode member are all made of metal,
the resistor base material and the first electrode member are bonded to each other by metal-bonding a metal constituting the resistor base material and a metal constituting the first electrode member, and
the resistor base material and the second electrode member are bonded to each other by metal-bonding the metal constituting the resistor base material and a metal constituting the second electrode member.

14. The method of manufacturing a chip resistor according to claim 12 wherein the preparing step includes a step of partially removing a region on the surface of the resistor base material between the first electrode member and the second electrode member to form a recess.
